(19) United States
(12) Patent Application Publication
(10) Pub. No.: US 2009/0015384 A1
(43) Pub. Date: Jan. 15, 2009

(54) METHOD AND DEVICE FOR DEFINITION OF THE ALLOCATION OF AN APPLIANCE TO ONE OF A PLURALITY OF POSSIBLE OPERATING POSITIONS, IN PARTICULAR IN THE CABIN OF AN AIRCRAFT

(75) Inventor: Jurgen Grabmann, Nurnberg (DE)

Correspondence Address: SCULLY SCOTT MURPHY & PRESSER, PC, 400 GARDEN CITY PLAZA, SUITE 300, GARDEN CITY, NY, 11530, US

(73) Assignee: DIEHL AEROSPACE GMBH, Uberlingen (DE)

(21) Appl. No.: 12/139,578

(22) Filed: Jun. 16, 2008

(30) Foreign Application Priority Data
Jul. 13, 2007 (DE) 102007032697.3

(51) Int. Cl. H04Q 5/22

(52) U.S. Cl. 340/10.42

(57) ABSTRACT

An automatic definition process is carried out for a control unit (11) to define which appliance (14) of a group of appliances is operated at which position (13), for example along a bus system (12), when each position (13) is permanently equipped with an Ident transponder (16), which individualizes it and can be read without making contact, and whose identifier is in each case read during appliance installation by a reader (17) which is fixed to the appliance, and is transmitted together with its appliance address to the control unit (11).

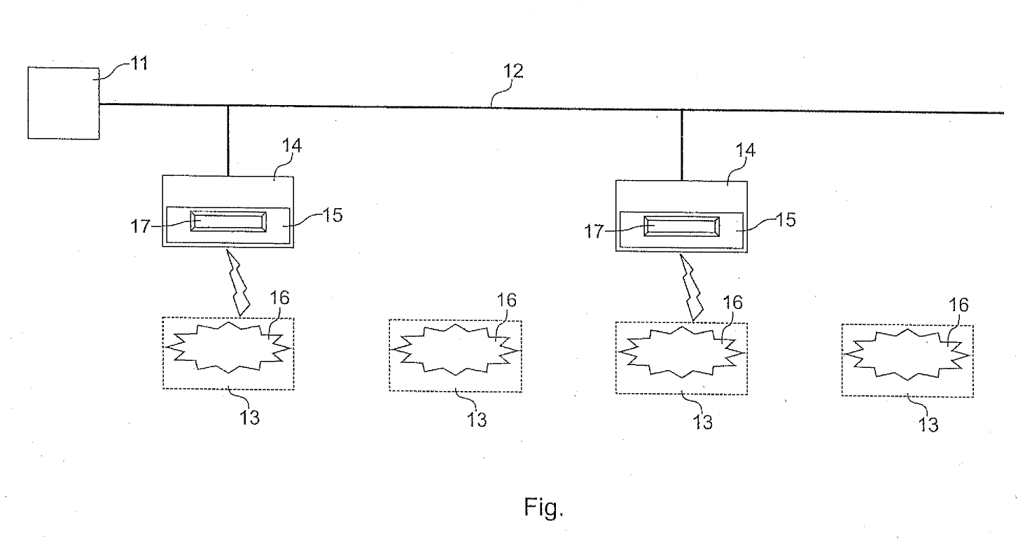

### BACKGROUND OF THE INVENTION

1. Field of the Invention

The present invention relates to a method for the definition of the allocation of at least one appliance to one of a plurality of possible operating positions. Moreover, the invention discloses a device for carrying out the inventive method.

In order to avoid having to connect every appliance which can be operated individually from a control unit, such as a light, a fan, a speech point, a sensor or the like, for example for building technology, in vehicles or in plant design, separately to associated outputs of a control unit, it is normal practice to address those appliances which are controlled by the control unit via a bus system.

2. Discussion of the Prior Art

However, incorporation in a bus system must also be documented in the same way as an individual connection to an associated output of the control unit; specifically with regard to the position at which the appliance which is individualized by its address is actually operated, in order that it can be appropriately operated, as well. The continual updating and availability of such documentation is, however, time-consuming and susceptible to errors. This becomes a particular cost driver where reorganizations of regroupings have to be carried out relatively frequently, such as during the conversion of the equipment in passenger cabins in aircraft, or else, for example, in long-distance buses.

### SUMMARY OF THE INVENTION

Accordingly, in recognition of these conditions, the present invention is based on solving the technical problem of allowing automatic error-free allocation to or association of appliances with their operating positions or locations.

According to the invention, the features achieve this object in that each appliance is equipped with a read circuit, which operates without making contact, for checking the identifier of a transponder, and each operating position in question is equipped with a transponder such as this, which can be interrogated without making contact, as a position-Ident transmitter. When the appliance is connected to one of a plurality of possible operating positions, the read circuit checks the identity of this operating position and signals it, expediently at the same time with the specific appliance address, as appliance identification, for example to a central control unit. There, it is then possible to call up the control and evaluation program that is individually associated with any position for operation of this particular appliance, without any need to now make manual allocation inputs for this purpose as well. This simplifies configuration changes: the position details that have now been allocated to an appliance are then transmitted to the control unit merely when an appliance is moved to a different position, or is additionally connected there.

The Ident transmitter is preferably a physically small RFID transponder which operates passively, that is to say without a specific energy source, with a magnetic long-wave antenna connected to its Ident chip. A transponder such as this is installed fixedly at each possible operating position, that is to say an operating position which can be fitted with an appliance, with its Ident coding therefore uniquely individualizing an entirely specific position in the circuit configuration. Its individual coding is checked without making contact when an appliance is mounted with its read circuit there in the course of appliance installation. The installed appliance therefore reads the Ident coding of its operating position and transmits this, preferably together with its own appliance address, to the control unit.

The function of a read circuit such as this is described in more detail, for example, in DE 1 97 17 505 A1. Because of the constant reading distance, which is particularly small and governed by the design in the present case, between the appliance and its connection point to its operating position, the read circuit may, however, in this case be designed to be extremely simple in comparison to that there.

The hardware complexity and the space required for this checking and identification system comprising a mobile read circuit and stationary transponder is therefore significantly less than, for example, the use of pairs of plug strips for each operating position, with a mechanical position coding by means of its plug pins; this is particularly true when a very large number of possible operating positions require correspondingly extensive coding.

In principle, the read circuit in the appliance may be operated only once, specifically in order to check the position on and as a consequence of the appliance installation. However, it may be expedient to activate it once again not only as a consequence of appliance installation but furthermore also, for example, periodically, on demand or as a function of predetermined operating circumstances; in order for example to carry out a verification and documentation process from time to time during operation when using particularly functionally critical appliances, to ensure that the registered appliance is actually still being operated at the position that was already sensed at an earlier time; and to confirm the position from which an appliance which was previously operated there has been removed.

### BRIEF DESCRIPTION OF THE DRAWING

Additional developments and alternatives will become evident with regard to their advantages, from the following description of one preferred exemplary embodiment, which is represented in a highly abstracted form, showing only what is significant to its operation, relating to the solution according to the invention. The single FIGURE of the drawing shows, in a symbolically simplified form, appliance connection options to individualized operating positions along a bus system.

In order to simplify the illustration, the drawing shows an outline of a two-conductor bus 12, which is connected to a control unit 11, for transmission of addresses and of control information (in addition to the power supply that is not illustrated) to appliances 14. Operating positions 13 for connection of identical or different appliances 14 are accessible in a distributed form along the bus 12. For this purpose, the appliances 14 are equipped with adaptors 15 which, as in the sketch, may be designed for electromechanical connection using pins, or else using other plug-in or screwthreaded sockets or magnetic contacts, with corresponding connection devices such as the sketched sockets at the operating positions 13.

In order to avoid having to separately document which appliance 14 is currently being operated at which of the various possible positions 13, a transponder 16 whose binary code actually individualizes a specific position 13 is installed in the immediate vicinity of the connection area of each of these positions 13. The association of the positions 13 with their codes is recorded once on initial fit, and is stored, for example, in the control unit 11. Since one of the appliances 14 is connected by means of its adaptor 15 to the bus 12 at one of the positions 13, a read circuit 17 which is fixed to the appliance, for example arranged in the adaptor 15 as sketched, checks the position identifier from the fixed-position transponder 16 and transmits this spontaneously or on demand, together with its individualization for example in the form of the appliance address, via the bus 12 to the control unit 11. This confirms, for example, that this one of the appliances 14 is being operated at the position 13 “at the extreme right” and must therefore experience, via the control unit 1I for example, different air conditioning that is appropriate for this specific operating position 13, from one of the appliances 14 which, for example, is being operated at the “front centre” position 13.

According to the invention, this therefore provides a control unit 11 with automatic definition of which appliance 14 is currently being operated at which position 13 for example along a bus system 12, in that each position 13 is permanently equipped with an Ident transponder 16 which individualizes it and can be read without making contact and whose identifier is actually read for the first time on appliance installation by a read circuit 17 that is fixed to the appliance, and is transmitted together with its appliance address to the control unit 11.

What is claimed is:

1. A method for a definition of the allocation of at least one appliance to one of a plurality of possible operating positions, wherein each of the positions has an identifier permanently allocated thereto, which individualizes the positions, said appliance reading out an appliance at its operating position, and which is transmitted as a position identifier to a control unit.

2. A method according to claim 1, wherein the position identifier is transmitted with an appliance information to the control unit.

3. A method according to claim 1, wherein the position identifier is read out with the installation of the respective appliance at said position.

4. A method according to claim 2, wherein the position identifier is also occasionally read during appliance operation, and is transmitted to the control unit.

5. A device for obtaining a definition of the allocation of at least one appliance to one of a plurality of possible operating positions, wherein said operating positions (13) are equipped with Ident transponders (16) and the appliances (14), which are there operable and are equipped with transponder read circuits (17).

6. A device according to claim 5, wherein RFID transponders (16) are provided at the operating positions (13).

7. A device according to claim 5, wherein contactless operating read circuits (17) are provided on the appliances (14).
